(19) United States
(12) Patent Application Publication
(10) Pub. No.: US 2005/0257801 A1
(43) Pub. Date: Nov. 24, 2005

(54) Method of using dental floss

(76) Inventor: Steven L. Kayser, San Diego, CA (US)

Correspondence Address: DUCKOR SPRADLING METZGER, 401 WEST A STREET, SUITE 2400, SAN DIEGO, CA, 92101-7915, US

(21) Appl. No.: 10/851,343

(22) Filed: May 21, 2004

(51) Int. Cl. A45D 24/00; A61C 15/00

(52) U.S. Cl. 132/200; 132/321

(57) ABSTRACT

According to one embodiment of the invention, there is provided a one-handed flossing method for using a dental floss loop by performing a series of steps performed on one hand for tensioning suitably a flossing portion of the endless loop for flossing purposes. The method includes tensioning the dental floss loop between the fingers and the thumb of the same hand, and then further tensioning the loop by pressing on it with at least one of the other digits of the hand. According to another embodiment of the invention, a particle discharging method using a dental floss loop includes anchoring inside the mouth a stretched flossing portion of the loop extending between the teeth, and pulling forcibly on the flossing portion extending out of the mouth to stretch the flossing portion away from the mouth to dislodge an unwanted particle. The tensioned dental floss loop is then placed between the teeth for flossing.

### FIELD OF THE INVENTION

The present invention relates in general to a method of using dental floss. The invention more particularly relates to a method of using a dental floss endless loop composed of a stretchable material.

### BACKGROUND ART

There is no admission that the background art disclosed in this section legally constitutes prior art.

In U.S. Pat. No. 6,371,133 entitled, “VARIABLE-GAUGE TOOTH-FLOSSING LOOPS,” incorporated herein by reference, there is disclosed an elastic dental floss loop. In the '133 patent, it states that the loop is suitable for use by the general public, and is designed for easy manipulation even among geriatrics, as well as children sometimes lacking developed finger dexterity.

In use, the patented flossing loop is generally held taut between thumb and forefinger of both hands, while positioned vertically into the interstitial regions of the teeth. The patented floss loop provides a desirably slight abrading action during a conventional up and down repetitive motion, sufficient as to effectively burnish away substances from the interstitial regions of the teeth, as well as the sulcus of the supporting gum-tissue. The '133 patent teaches the use of the dental floss loop by tensioning the loop by stretching it between the fingers of both hands during interstitial ingress/egress of the floss, causing the stretched portion to readily shrink under tension into an almost film-like thickness, thereby easily slipping past difficult interstitial constrictions.

### DESCRIPTIONS OF THE DRAWINGS

The following is a brief description of the drawings:

FIGS. 1, 2, 3, 4 and 5 are pictorial views of a one hand method for using a dental floss endless loop in accordance with an embodiment of the invention; and

FIGS. 6, 7 and 8 are pictorial views of particle dislodgement methods for using a dental floss endless loop in accordance with another embodiment of the invention.

### DETAILED DESCRIPTION OF CERTAIN EMBODIMENTS OF THE INVENTION

According to one embodiment of the invention, there is provided a one-handed flossing method for using a dental floss loop by performing a series of steps performed on one hand for tensioning suitably a flossing portion of the endless loop for flossing purposes. The method includes tensioning the dental floss loop between the fingers and the thumb of the same hand, and then further tensioning the loop by pressing on it with at least one of the other digits of the hand. According to another embodiment of the invention, a particle discharging method using a dental floss loop includes anchoring inside the mouth a stretched flossing portion of the loop extending between the teeth, and pulling forcibly on the flossing portion extending out of the mouth to stretch the flossing portion away from the mouth to dislodge an unwanted particle. The tensioned dental floss loop is then placed between the teeth for flossing.

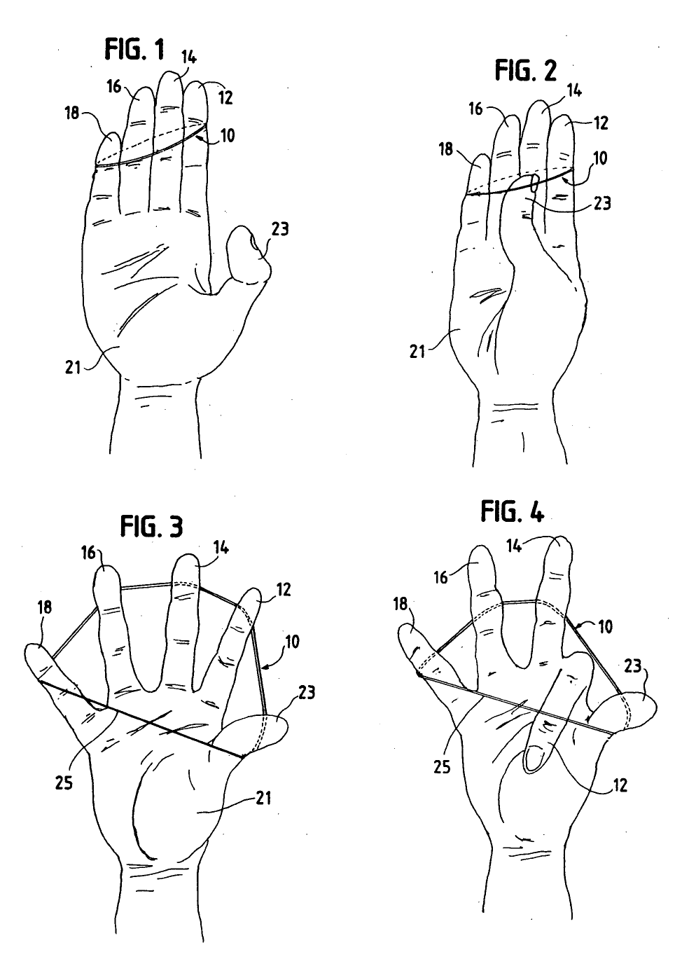

Referring now to the drawings, and more particularly to FIGS. 1-5 thereof, there is shown a one-handed method of using a stretchable resilient dental floss endless loop 10 for teeth flossing. The loop 10 may be the loop disclosed in the foregoing mentioned U.S. Pat. No. 6,371,133, or may be other stretchable loops.

As shown in FIG. 1, the endless loop 10 and a hand 21 of the user are placed in an operative relationship where the endless loop 10 is placed or slipped around at least two digits such as the four digits 12, 14, 16 and 18 which represent the index finger, middle finger, ring finger and little finger, respectively. The dental floss loop 10 is placed around the digits in preparation for creating tension thereon. It is not required that the endless loop 10 be placed around all four digits as one or more of the digits may be placed outside the endless loop, if desired.

During this step, the dental floss loop 10 may be positioned between the first and second knuckle of the digit 12 and around the first knuckle of the digit 18 as indicated in FIG. 1. To maintain this position, the digits 12, 14, 16, or 18 may have to be fixedly positioned or manipulated in such a way to keep endless loop 10 in a relatively stable and fixed position in relation to the digits as indicated in FIG. 1. However, depending on the size and shape of the user's hand, the endless loop 10 could be positioned around other parts of the digits since the relative position of the endless loop 10 to the digits is not critical, as the size and shape of the hand will vary depending on the user.

Referring now to FIG. 2, a thumb 23 of hand 21 is slipped inside the endless loop 10 opposite the digits 14 and 16. This step may be performed to prepare for a subsequent step of creating tension on the loop 10. Depending on the size and shape of the hand 21, the thumb 23 may be positioned opposite other digits such as the little finger or index finger when placed inside the endless loop 10. During this step, the endless loop 10 may be maintained between the first and second knuckles or joints of the index finger 12 and the first knuckle or joint of the little finger as shown in FIG. 2. However, depending on the size and shape of the user's hand, the loop 10 may be positioned surrounding other parts of the digits as the relative position of the endless loop 10 with respect to the digits is not critical. To maintain this position, the digits 12, 14, 16, or 18 or thumb 23 may have to be fixedly positioned or manipulated in a suitable way to maintain the loop 10 in a relatively fixed position in relation to the digits.

Referring now to another step in the method, as shown in FIG. 3, the digit 18 and thumb 23 are moved away from each other in order to stretch the loop 10 thereby creating tension at a portion of the loop 10 generally shown at section or portion 25. Depending on what digits were originally placed within the loop 10 in the initial step, the remaining digits such as the digits 12, 14 and 16 are moved apart to help stretch the loop 10. The digit may be used in coordination with the thumb 23 to stretch the loop 10 to surround and spread apart the digits and the thumb. During this step, it is desirable that the loop 10 be disposed surrounding the tips or distal ends of the digits 12, 14 and 16 of the hand 21 as generally shown in FIG. 3 where the loop 10 is positioned near the tips of each of these digits.

In stretching the loop 10 with the digits and thumb, the loop 10 is manipulated by the fingers and thumb until the loop 10 is disposed closer to the tips of the digits 12, 14 and 16 as shown in FIG. 3. This may be accomplished using the same hand 21 without assistance from the user's other hand (not shown).

It is to be understood that the loop 10 may be positioned at other locations around other parts of the digits. To maintain the loop 10 in position, the digits of the hand may have to be fixedly positioned or manipulated in a suitable way to maintain the loop 10 in a relatively stable and fixed position around the digits near the tips of the digits 12, 14 and 16.

With reference now to FIG. 4, the digit 12, or another capable digit, is bent toward the palm of the hand 21 and slipped under a section or portion 25 of the loop stretched between the thumb 23 and the little finger 18. Thus, the digit 12 is moved to a position underneath the tensioned section 25 of the loop 10 in preparation for providing a larger amount of tension in the previously tensioned section 25 of the loop 10. As described in the previous steps, the digits may require to be fixedly positioned or manipulated in such a way as to maintain the loop 10 in a relatively stable and fixed position surrounding the digits including the thumb 23 while this step is being performed.

As shown in FIG. 5, the digit 12 is straightened to raise it to press against the section or portion 25 stretched between the thumb 23 and the little finger 18 to provide additional tension on the loop 10 at the section 25. A high tension section 26 of the loop 10 is now disposed between the thumb 23 and the digit 12 and serves as a flossing portion of the loop 10. At this step, the flossing portion 26 is being held at sufficient tension to be capable of being inserted between teeth (not shown) for flossing purposes. The high tension flossing portion 26 may be inserted between teeth to floss them in a conventional flossing technique, except that it may be accomplished by using a single hand of the user. Again, as described with the previous steps, the digits may have to be fixedly positioned or manipulated in such a way as to maintain the loop 10 and high tension flossing portion 26 in a relatively stable fixed position around the digits and thumb as shown in FIG. 5 during the flossing operation.

According to other embodiments of the invention, there is provided a method for using a dental floss endless loop for flossing teeth using two hands to dislodge unwanted particles wedged between the teeth by using a resilient stretchable dental floss loop such as the one disclosed in the foregoing mentioned patent. According to the disclosed embodiments, the method includes a series of steps for increasing tension on certain portions of the loop so that a suitable amount of tension is placed on a portion of the loop suitable for flossing. The method may include wrapping the dental floss around one digit on a first hand and around one digit on the other hand and stretching the endless loop to create a stretched flossing portion between the two hands. The stretched flossing portion of the loop is then placed between a pair of teeth where the first hand anchors the flossing portion of the loop within the mouth. The endless loop then dislodges an unwanted particle from between the teeth when the second hand pulls on the flossing extending out of the mouth to stretch it away from the mouth.

The stretching of the flossing portion away from the mouth may be accomplished by a single abrupt jerking motion to dislodge the particle. Alternatively, the stretching of the flossing portion may be accomplished by a repetitive back and forth motion of the second hand to alternating stretching and releasing the flossing portion.

Thus, according to other embodiments of the invention, there is provided an enhanced method to remove unwanted particles from teeth which includes repeatedly moving the second hand repeatedly toward and away from the mouth until the particle is removed. As to the other embodiment of the invention for enhanced removal of unwanted particles from the teeth, the second hand may abruptly move away from the mouth to dislodge an unwanted particle.

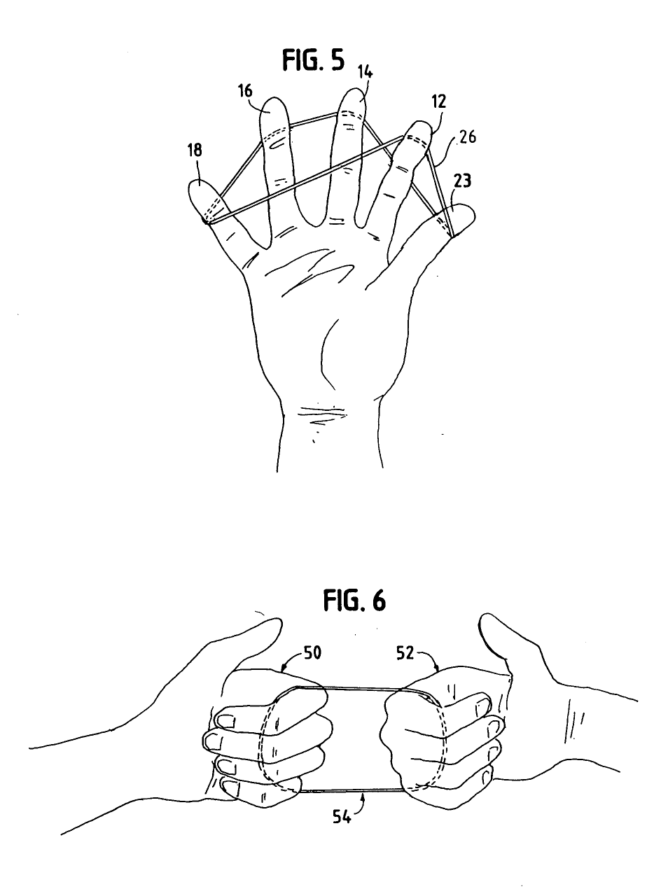

Referring now to the drawings, and more particularly to FIGS. 6-8 thereof, there is shown a method of flossing using dental floss such as a resilient stretchable dental floss endless loop 54 similar to the loop 10, with two hands to dislodge unwanted particles from between the teeth of the user. As shown in FIG. 6 the loop 54 may be slipped over the digits of the first hand 50 and the digits of the second hand 52. The fingers of each hand are bent toward the palms to grip the loop 54. The hands are then moved apart to stretch the loop 54. The first hand 50 and the second hand 52 are pulled slightly apart as shown in FIG. 6 to create tension on the loop 54 in preparation for creating additional tension as required for flossing.

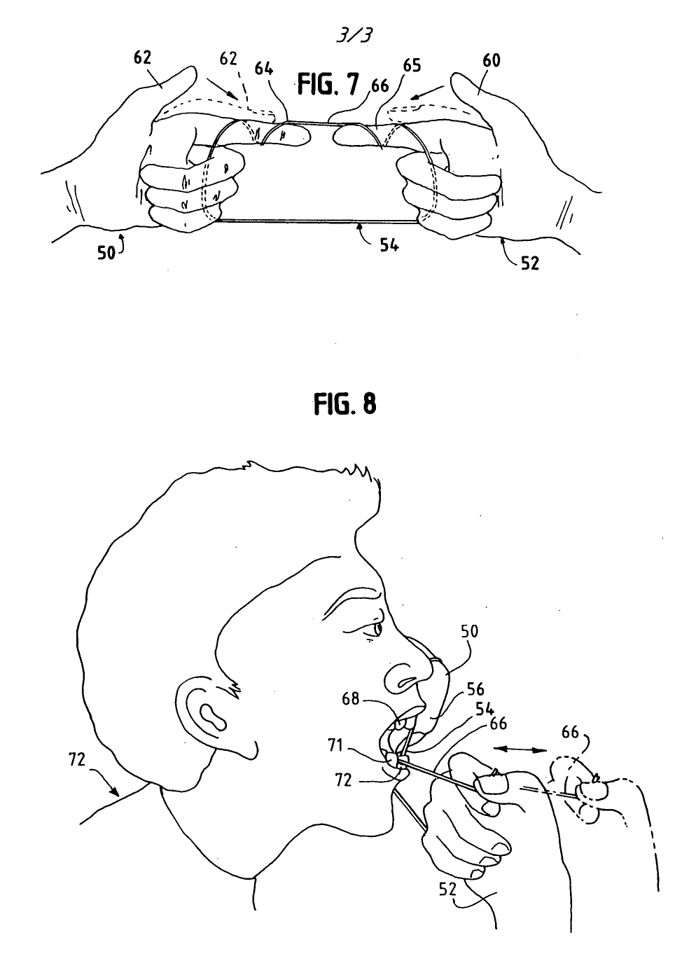

As shown in FIG. 7, forefingers 56 and 58 are then extended and moved to cause the loop 54 to be twisted around each forefinger at 64 and 65. The twisting anchors the loop 54 to the forefingers 56 and 58, and enables the user to pull the fingers 56 and 58 slightly apart to create additional tension on the loop 54 at a high tension flossing section or portion 66 extending between the fingers 56 and 58. To secure this configuration and to maintain high tension in the section 66, thumbs 62 and 60 of the respective hands 50 and 52 clamp down on sections 64 and 65 of the loop 54, as indicated in the broken lines in FIG. 7.

Referring now to FIG. 8, the flossing portion 66 is inserted into the mouth 68 of a user 72 between a pair of teeth such as teeth 71 and 72 by positioning the finger 56 of the hand 50 behind the teeth 71 and 72 inside the mouth 68. A particle (not shown) is caught firmly between the teeth 71 and 72, and is sought to be removed by the method of the disclosed embodiment of the invention. The loop 54 held by the hand 52 is positioned outside the mouth 68. The first hand 50 anchors the flossing portion 66 inside the mouth 68.

As indicated by the broken lines in FIG. 8, the second hand 52 pulls on the portion 66 to stretch it and cause the hand 52 to move away from the mouth 68 in the direction shown by the arrow. The second hand 52 pulls forcibly away from the mouth in an abrupt jerking manner in a single action in the direction of the arrow to cause the unexpected effect of dislodging the unwanted particles from between the teeth.

It will become apparent to those skilled in the art that in place of an endless loop, a stretchable dental floss tape, such as the one disclosed in U.S. Pat. No. 6,371,133 or other suitable stretchable tape may be employed for the particle discharging method as shown in FIGS. 6, 7 and 8.

In another embodiment, the second hand 52 is repeatedly and rapidly moved back and forth toward and away from the mouth 68. This has the effect of repeatedly stretching and contracting the endless loop 54 which also has the unexpected result of dislodging an unwanted particle or particles from between the teeth in a highly effective manner.

According to other embodiments of the invention, there is provided a method for using a dental floss endless loop for flossing teeth using either one hand or two hands where the dental floss endless loop deposits an agent on the teeth and gums. The agent may be effective in combating diseases of the teeth and gums. As best shown in FIG. 8 and as described in U.S. Pat. No. 6,371,133, the loop 54 may be coated with an agent (not shown) specifically designed to combat various diseases of the teeth and gums. Such agents include, but are not limited to, fluoride and antimicrobial chemical compounds. When endless loop 54, coated with an agent, is placed between teeth 71 and 72, the agent is deposited on the teeth 71 and 72 and gums (not shown) to help combat teeth and gum disease.

While the present embodiments of the invention as disclosed herein have been particularly shown and described with reference to particular embodiments thereof, it will be understood by those skilled in the art that various changes in form and details may be made therein without departing from the true spirit and scope of the present invention.

1. A method of flossing teeth with a single hand using a dental floss loop composed of a stretchable material, comprising:
disposing the dental floss loop surrounding at least two digits of the hand and the thumb;
stretching the dental floss device using the digits and the thumb of the hand to tension at least a portion of the loop;
pressing on the stretched loop to tension it; and
sliding the tensioned dental floss loop between the teeth.

2. A method as recited in claim 1, further including depositing an agent on the teeth effective in combating diseases of the teeth.

3. A method as recited in claim 2, wherein the agent is fluoride.

4. A method as recited in claim 2, wherein the agent is an antimicrobial.

5. A method as recited in claim 1, wherein the digits of the hand are fixedly positioned to maintain the endless loop in a stable and fixed position around the digits.

6. A method as recited in claim 1, wherein the digits of the hand are manipulated to maintain the endless loop in a stable and fixed position around the digits.

7. A method of dislodging particles from between teeth in a mouth using a dental floss device composed of a stretchable material, comprising:
disposing the dental floss device around at least one digit on a first hand and at least one digit on a second hand;
stretching the dental floss device using at least one digit of the first hand and at least one digit of the second hand to form a stretched portion thereof;
sliding the stretched portion of the dental floss device between a pair of teeth;
anchoring the stretched portion with the first hand within the mouth; and
pulling forcibly on the portion extending out of the mouth with the second hand away from the mouth to stretch the device to dislodge an unwanted particle from between the teeth.

8. A method as recited in claim 7, further including depositing an agent on the teeth effective in combating diseases of the teeth.

9. A method as recited in claim 8, wherein the agent is fluoride.

10. A method as recited in claim 8, wherein the agent is an antimicrobial.

11. A method as recited in claim 7, further including using the second hand to move repeatedly toward and away from the mouth.

12. A method as recited in claim 7, further including using the second hand to abruptly move away from the mouth.

13. A method as recited in claim 7, wherein the device is in the form of an endless loop.
